(19) United States
(12) Patent Application Publication
(10) Pub. No.: US 2026/0273985 A1
(43) Pub. Date: Sep. 17, 2026

(54) BIODEGRADABLE VALUE-DOCUMENT SUBSTRATE

(71) Applicant: GIESECKE+DEVRIENT CURRENCY TECHNOLOGY GMBH, Munchen (DE)

(72) Inventors: Christoph MENGEL, Holzkirchen (DE); Patrick RENNER, Reichersbeuern (DE); Matthias PFEIFFER, Munchen (DE); Harald LESCH, Anzing (DE); Thomas MANG, Holzkirchen (DE)

(21) Appl. No.: 19/474,437

(22) PCT Filed: Apr. 16, 2024
(86) PCT No.: PCT/DE2024/100319

§ 371 Date: Oct. 10, 2025

(30) Foreign Application Priority Data
Apr. 20, 2023 (DE) 10 2023 110 082.3

(51) Int. Cl. B42D 25/29; B42D 25/382; B42D 25/387; G07D 7/00; G07D 7/005

(52) U.S. Cl. CPC B42D 25/29; B42D 25/387; B42D 25/382; G07D 7/003; G07D 7/005

(57) ABSTRACT

A machine-recognizable, biodegradable, polymeric value-document substrate includes a polymeric composite substrate based at least substantially on renewable raw materials, and at least one machine-recognizable feature substance embedded in the composite substrate. The machine-recognizable feature substance exhibits a characteristic luminescent emission when excited with light of a suitable wave-length, in particular when excited with light in the UV wavelength range or IR wavelength range.

The invention relates to a machine-recognizable, biodegradable, polymeric value-document substrate, in particular a banknote.

Value-document substrates based on plastics, in particular polymer banknotes, are known in the prior art. Document WO 83/00659 A1 describes a substrate based on a transparent, biaxially oriented polymer for the production of banknotes or identity cards. Furthermore, document WO 2004/028825 A2 describes a composite film/paper/film substrate as a suitable value-document substrate for the production of banknotes.

Value documents, in particular banknotes, are exposed to high stresses during circulation of the value documents, leading to soiling and mechanical damage. Typically, machine-recognizable feature substances, which serve for machine recognition of the value-document substrate, are applied to the value-document substrate in a printing ink or coating system provided with the machine-recognizable feature substance, and can therefore easily be lost due to mechanical abrasion during circulation of the value documents. Furthermore, the feature substance located at the surface of the value-document substrate can be easily removed by a forger and used for the production of forged value documents.

In addition, the existing polymeric value-document substrates are based on plastics such as, for example, biaxially oriented polypropylene (BOPP). Such plastics are obtained from fossil raw materials and are also not biodegradable.

The object of the present invention is to overcome the disadvantages of the prior art and to provide an improved value-document substrate. In particular, the value-document substrate is intended to ensure sustainable and environmentally friendly disposability and production, while at the same time possessing high circulation stability.

This object is achieved by the combination of features defined in the independent claim. Developments of the invention are the subject of the dependent claims.

### SUMMARY OF THE INVENTION

The invention contains a machine-recognizable, biodegradable, polymeric value-document substrate comprising a polymeric composite substrate based at least substantially on renewable raw materials, and at least one machine-recognizable feature substance embedded in the composite substrate, wherein the machine-recognizable feature substance exhibits a characteristic luminescent emission when excited with light of a suitable wavelength, in particular when excited with light in the UV wavelength range or IR wavelength range.

A “biodegradable” value-document substrate is understood here as a material that can be decomposed by microorganisms into end products that are toxicologically harmless. In addition to water and biomass, CO₂ is also produced here. The decomposition process can be accelerated by large-scale composting plants or biogas plants.

In an advantageous configuration, the polymeric composite substrate based at least substantially on renewable raw materials has at least two interconnected polymer layers, wherein the machine-recognizable feature substance is embedded in one of the at least two interconnected polymer layers, wherein the machine-recognizable feature substance is preferably embedded in only one of the at least two interconnected polymer layers.

In a likewise advantageous configuration, the polymeric composite substrate based at least substantially on renewable raw materials has at least two polymer layers connected to each other by an adhesive lamina, wherein the machine-recognizable feature substance is embedded in the adhesive lamina.

In a further advantageous configuration, the polymeric composite substrate based at least substantially on renewable raw materials has two outer polymer layers and a central lamina, wherein the central lamina is a polymer layer or a paper lamina, wherein the two outer polymer layers and the central lamina are connected to each other by two adhesive laminas, wherein the machine-recognizable feature substance is embedded at least in one of the two adhesive laminas, wherein the machine-recognizable feature substance is preferably embedded in only one of the two adhesive laminas.

With particular advantage, the value-document substrate has two different machine-recognizable feature substances, wherein the two feature substances are individually embedded in different constituents of the value-document substrate, in order in this way to form separate value-document substrate regions which are distinguishable from each other on the basis of the respective feature substance.

The polymeric composite substrate based at least substantially on renewable raw materials is based advantageously on starch, starch derivatives, cellulose, cellulose derivatives, cellulose diacetate (CDA), lignin, polylactic acid or polylactide (PLA), polyhydroxy fatty acids (PHF), in particular polyhydroxybutyrate (PHB) and/or polyhydroxyvalerate (PHV), polybutylene adipate terephthalate (BTA copolyester), chitin, chitosan or casein, or on a mixture of two or more of the aforesaid substances.

Advantageously, the machine-recognizable feature substance embedded in the composite substrate is recognizable in daylight with the naked eye and is preferably in the form of fibers, mottled fibers, planchettes or particles.

According to another advantageous variant of the invention, the machine-recognizable feature substance embedded in the composite substrate is not recognizable in daylight with the naked eye, but is recognizable with the naked eye only on irradiation with UV light and is preferably in the form of fibers, mottled fibers, planchettes or particles.

In a further advantageous variant of the invention, the machine-recognizable feature substance embedded in the composite substrate is not recognizable with the naked eye, is in the form of particles, namely pigments, and exhibits a characteristic luminescent emission when excited with light in the UV wavelength range or IR wavelength range.

Preferably, the machine-recognizable feature substance is an inorganic substance and is in the form of a host lattice doped with luminescent ions.

According to a preferred configuration, the value-document substrate is a banknote.

### DETAILED DESCRIPTION OF THE PREFERRED EMBODIMENTS

The invention is based on the finding that a sustainable value-document substrate can be provided which can be disposed of in an environmentally friendly manner and at the same time has high circulation stability and machine recognizability, in that the value-document substrate comprises a polymeric composite substrate based at least substantially on renewable raw materials, and at least one machine-recognizable feature substance embedded in the composite substrate, wherein the machine-recognizable feature substance exhibits a characteristic luminescent emission when excited with light of a suitable wavelength, in particular when excited with light in the UV wavelength range or IR wavelength range.

The value-document substrate of the invention and the value document obtainable from it, in particular a banknote, have an advantageous sustainability and a low CO2 footprint. The value documents obtainable on the basis of the value-document substrate of the invention are recyclable and biodegradable, i.e., compostable, up to the end of the product life cycle. At the same time, the value-document substrate and the value document obtained from it can be reliably checked for authenticity by virtue of the machine-recognizable feature substance embedded in the composite substrate. In view of the embedding, the machine-recognizable feature substance is, so to speak, internal, so that during circulation of the value document there is no loss of the feature substance due to mechanical abrasion of the printing ink or paint system applied to the surface of the value document. Furthermore, the internal, machine-recognizable feature substance cannot be removed by a counterfeiter and used for the production of forged value documents.

The machine-recognizable feature substance which exhibits a characteristic luminescent emission when excited with light of a suitable wavelength can be excited to the emission in particular with light in the UV wavelength range or IR wavelength range.

According to one preferred embodiment, the machine-recognizable feature substance is recognizable in daylight with the naked eye and is in particular in the form of fibers, mottled fibers, planchettes or particles. The technical advantage of this embodiment is that the authenticity of the respective value document can be verified without an additional technical aid.

According to a further preferred embodiment, the machine-recognizable feature substance is not recognizable in daylight with the naked eye, but is recognizable with the naked eye only on irradiation with UV light and is in particular in the form of fibers, mottled fibers, planchettes or particles. The technical advantage of this embodiment is that verifying the authenticity of the respective value document necessitates an additional technical aid, in particular a UV lamp, and the simulation of a corresponding value document requires increased technical effort. The forgery-proofness is thus greatly increased.

According to a further preferred embodiment, the machine-recognizable feature substance is not recognizable with the naked eye, is in the form of particles, namely pigments, and exhibits a characteristic luminescent emission when excited with light in the UV wavelength range or IR wavelength range. For machine recognition, a luminescence microscope or a banknote inspection system equipped with suitable sensors is required. The particles advantageously have a grain size D99 in a range from 1 micron to 30 microns, preferably in a range from 5 microns to 20 microns, more preferably in a range from 10 microns to 20 microns and in particular preferably in a range from 15 microns to 20 microns. The technical advantage of this embodiment is that verifying the authenticity of the respective value document is possible only by means of a technically complex method such as, for example, luminescence spectroscopy. The forgery-proofness is therefore extremely high. The machine-recognizable feature substance is advantageously an inorganic substance and is preferably in the form of a host lattice doped with luminescent ions.

The value-document substrate of the invention comprises a polymeric composite substrate based at least substantially on renewable raw materials. According to one preferred embodiment, the polymeric composite substrate has at least two interconnected polymer layers, wherein the machine-recognizable feature substance is embedded in one of the at least two interconnected polymer layers. It is preferred that the machine-recognizable feature substance is embedded in only one of the at least two interconnected polymer layers. The embedding of the feature substance in only one of the at least two interconnected polymer layers improves the anticounterfeit protection of the respective value document. In the event of manipulative splitting of the two interconnected polymer layers, it is no longer possible for the counterfeiter to employ two equivalent polymer layers for producing two forged value documents.

In principle, the feature substance can be embedded over the full area or partially, i.e., in regions. In the case of partial embedding, embedding can take the form of characters, of coding or of a pattern such as stripes or blocks, for instance, according to requirement.

According to a further preferred embodiment, the polymeric composite substrate has at least two polymer layers connected to each other by an adhesive lamina, wherein the machine-recognizable feature substance is embedded in the adhesive lamina. In this case too, the feature substance can be embedded over the full area or partially, i.e., in regions.

According to another preferred embodiment, the polymeric composite substrate has two outer polymer layers and a central lamina, wherein the central lamina is a polymer layer or a paper lamina, wherein the two outer polymer layers and the central lamina are connected to each other by two adhesive laminas, wherein the machine-recognizable feature substance is embedded at least in one of the two adhesive laminas, wherein the machine-recognizable feature substance is preferably embedded in only one of the two adhesive laminas. The embedding of the feature substance in only one of the two adhesive laminas improves the anticounterfeit protection of the respective value document. In the event of manipulative splitting of the triplex composite, it is no longer possible for the counterfeiter to employ two equivalent halves to produce forged value documents. In principle, a value-document substrate with a polymer layer/paper substrate/polymer layer structure, which is also referred to as a film composite substrate, is known in the prior art; see document WO 2004/028825 A2.

According to a further preferred embodiment, the polymeric composite substrate has two outer polymer layers and a central polymer layer, wherein in particular the central polymer layer is based on renewable raw materials and the two outer polymer layers are constituted such that they each improve the printability of the value-document substrate with ink, in order thereby to provide an ink acceptance layer or print acceptance layer. The outer polymer layers may judiciously each be a thin polyethylene terephthalate (PET) lamina, which is optionally provided at the surface with an ink acceptance-or print acceptance-improving composition, the composition being based in particular on a polymeric binder and filler pigments such as, for instance, SiO₂ pigments, TiO₂ pigments or Al₂O₃ pigments. Ink acceptance layers are known in the prior art, see for example the document WO 2012/003947 A1.

According to a further preferred embodiment, the value-document substrate according to the invention has two different machine-recognizable feature substances, wherein the two feature substances are individually embedded in different constituents of the value-document substrate, in order in this way to form separate value-document substrate regions which are distinguishable from each other on the basis of the respective feature substance. For example, one feature substance may be embedded in a first polymer layer and the further feature substance embedded in a second polymer layer. Alternatively, one feature substance may be embedded in a polymer layer and the further feature substance embedded in an adhesive lamina.

The polymeric composite substrate which is based at least substantially on renewable raw materials may be based in particular on starch, starch derivatives, cellulose, cellulose derivatives, cellulose diacetate (CDA), lignin, polylactic acid or polylactide (PLA), polyhydroxy fatty acids (PHF), in particular polyhydroxybutyrate (PHB) and/or polyhydroxyvalerate (PHV), polybutylene adipate terephthalate (BTA copolyester), chitin, chitosan or casein, or on a mixture of two or more of the aforesaid substances. Cellulose diacetate (CDA) in particular has very positive properties for the technical processability.

According to a further preferred variant, the value-document substrate of the invention is such that it has a security thread and/or a security strip and/or a security patch based on a biodegradable material and/or on natural fiber-based mottled fibers. In this way, a value-document substrate which is particularly advantageous in terms of recyclability can be provided.

The value-document substrate of the invention is in particular a banknote or a security paper suitable for the production of banknotes.

Further working examples and advantages of the invention are elucidated hereinafter with reference to the figures, the representation of which dispenses with reproduction to scale and in proportion, in order to increase illustrativeness.

In the figures,

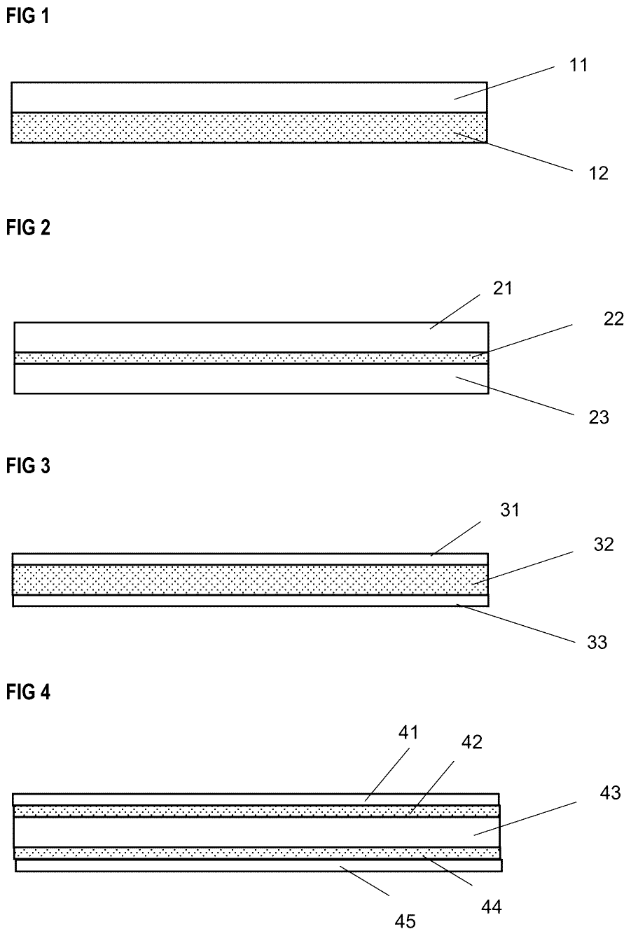

FIG. 1 shows a value-document substrate according to a first working example in cross-sectional view;

FIG. 2 shows a value-document substrate according to a second working example in cross-sectional view;

FIG. 3 shows a value-document substrate according to a third working example in cross-sectional view; and

FIG. 4 shows a value-document substrate according to a fourth working example in cross-sectional view.

According to a first working example, FIG. 1 illustrates a machine-recognizable, biodegradable, polymeric value-document substrate of the invention, comprising a polymeric composite substrate having two interconnected polymer layers 11 and 12. A machine-recognizable feature substance is embedded only in polymer layer 12. Biodegradable polybutylene adipate terephthalate (BTA copolyester) was used for the production of polymer layers 11 and 12. As a machine-recognizable feature substance, an inorganic substance known from document WO 2011/084663 A2 was used, which is in the form of individual particles not recognizable with the naked eye and is based on a host lattice doped with luminescent ions. The feature substance can be detected by means of a luminescence microscope and has the molecular formula Y_{2.88}Er_{0.1}Tm_{0.01}Ho_{0.01}Ga₅O₁₂. The matrix or host lattice comprises the elements Y, Ga and O. The dopants are formed by the elements Er, Tm and Ho.

The embedding of the feature substance in only one of the at least two interconnected polymer layers improves the anticounterfeit protection of the respective value document. In the event of manipulative splitting of the two interconnected polymer layers, it is no longer possible for the counterfeiter to employ two equivalent polymer layers for producing two forged value documents. In addition, the value-document substrate ensures sustainable and environmentally friendly disposability and at the same time has high circulation stability, because the feature substance is provided internally and is thus protected with regard to mechanical wear.

According to a second working example, FIG. 2 illustrates a machine-recognizable, biodegradable, polymeric value-document substrate of the invention, comprising a polymeric composite substrate having two polymer layers 21 and 23 connected to each other via an intermediate lamina 22, namely an adhesive lamina. A machine-recognizable feature substance is embedded only in the intermediate lamina 22. Biodegradable polylactic acid or polylactide (PLA) was used for the production of polymer layers 21 and 23. As a machine-recognizable feature substance, mottled fibers recognizable with the naked eye when irradiated with UV light were used. The value-document substrate can be verified for authenticity with the naked eye using a UV lamp for assistance and has a sustainable and environmentally friendly disposability. In addition, high circulation stability is ensured, because the feature substance is provided internally and is thus protected with regard to mechanical wear.

According to a third working example, FIG. 3 illustrates a machine-recognizable, biodegradable, polymeric value-document substrate of the invention, which is in the form of a three-layer polymer composite with the polymer layers 31, 32 and 33. The polymer layers are each based on polyhydroxybutyrate (PHB). A machine-recognizable feature substance is embedded only in the central polymer layer 32. As a machine-recognizable feature substance, an inorganic substance known from document EP 1 241 242 A2 was used, which is in the form of individual particles not recognizable with the naked eye and is based on a host lattice doped with luminescent ions. The feature substance can be detected by means of a luminescence microscope and has the molecular formula Gd_{1.89}Yb_{0.1}Tm_{0.01}O₂S. The value-document substrate ensures sustainable and environmentally friendly disposability and at the same time has high circulation stability, because the feature material is provided internally and is thus protected with regard to mechanical wear.

According to a fourth working example, FIG. 4 illustrates a machine-recognizable, biodegradable, polymeric value-document substrate of the invention, which is in the form of a five-layer polymer composite. The polymeric composite substrate comprises two outer polymer layers 42 and 44 and a central polymer layer 43, with the central polymer layer 43 being based on renewable raw materials, e.g. polybutylene adipate terephthalate (BTA copolyester). In the present example, polymer layers 42 and 44 are each a thin polyethylene terephthalate (PET) lamina, in each of which a machine-recognizable feature substance is embedded. The polymer layers 42 and 44 each have at the surface an ink acceptance layer 41 and 45, respectively, improving the printability of the value-document substrate with printing ink. The two ink acceptance layers 41 and 45 are each based on a composition based on a polymeric binder and filler pigments.

1-11. (canceled)

12. A machine-recognizable, biodegradable, polymeric value-document substrate comprising a polymeric composite substrate based at least substantially on renewable raw materials, and at least one machine-recognizable feature substance embedded in the composite substrate,
wherein the machine-recognizable feature substance exhibits a characteristic luminescent emission when excited with light of a suitable wavelength, when excited with light in the UV wave-length range or IR wavelength range.

13. The machine-recognizable, biodegradable, polymeric value-document substrate according to claim 12,
wherein the polymeric composite substrate based at least substantially on renewable raw materials has at least two interconnected polymer layers,
wherein the machine-recognizable feature substance is embedded in one of the at least two interconnected polymer layers,
wherein the machine-recognizable feature substance is embedded in only one of the at least two interconnected polymer layers.

14. The machine-recognizable, biodegradable, polymeric value-document substrate according to claim 12,
wherein the polymeric composite substrate based at least substantially on renewable raw materials has at least two polymer layers connected to each other by an adhesive lamina,
wherein the machine-recognizable feature substance is embedded in the adhesive lamina.

15. The machine-recognizable, biodegradable, polymeric value-document substrate according to claim 12,
wherein the polymeric composite substrate based at least substantially on renewable raw materials has two outer polymer layers and a central lamina,
wherein the central lamina is a polymer layer or a paper lamina,
wherein the two outer polymer layers and the central lamina are connected to each other by two adhesive laminas,
wherein the machine-recognizable feature sub-stance is embedded at least in one of the two adhesive laminas,
wherein the machine-recognizable feature substance is embedded in only one of the two adhesive laminas.

16. The machine-recognizable, biodegradable, polymeric value-document substrate according to claim 12,
wherein the value-document substrate has two different machine-recognizable feature substances,
wherein the two feature substances are individually embedded in different constituents of the value-document substrate, in order in this way to form separate value-document substrate regions which are distinguishable from each other on the basis of the respective feature substance.

17. The machine-recognizable, biodegradable, polymeric value-document substrate according to claim 12,
wherein the polymeric composite substrate based at least substantially on renewable raw materials is based on starch, starch derivatives, cellulose, cellulose derivatives, cellulose diacetate (CDA), lignin, polylactic acid or polylactide (PLA), polyhydroxy fatty acids (PHF), including polyhydroxybutyrate (PHB) and/or polyhydroxyvalerate (PHV), polybutyl-ene adipate terephthalate (BTA copolyester), chitin, chitosan or casein, or on a mixture of two or more of the aforesaid substances.

18. The machine-recognizable, biodegradable, polymeric value-document substrate according to claim 12,
wherein the machine-recognizable feature substance embedded in the composite substrate is recognizable in daylight with the naked eye and is in the form of fibers, mottled fibers, planchettes or particles.

19. The machine-recognizable, biodegradable, polymeric value-document substrate according to claim 12,
wherein the machine-recognizable feature substance embedded in the composite substrate is not recognizable in daylight with the naked eye, but is recognizable with the naked eye only on irradiation with UV light and is in the form of fibers, mottled fibers, planchettes or particles.

20. The machine-recognizable, biodegradable, polymeric value-document substrate according to claim 12,
wherein the machine-recognizable feature substance embedded in the composite substrate is not recognizable with the naked eye, is in the form of particles, and exhibits a characteristic luminescent emission when excited with light in the UV wavelength range or IR wavelength range.

21. The machine-recognizable, biodegradable, polymeric value-document substrate according to claim 20,
wherein the machine-recognizable feature substance is an inorganic substance and is in the form of a host lattice doped with luminescent ions.

22. The machine-recognizable, biodegradable, polymeric value-document substrate according to claim 12, wherein the value-document substrate is a banknote.
